(19) United States
(12) Patent Application Publication
(10) Pub. No.: US 2004/0126587 A1
(43) Pub. Date: Jul. 1, 2004

(54) Polyurethane laminates for photochromic lenses

(76) Inventors: Alan Maki, Chaska, MN (US); Eric Woelfle, Princeton, MN (US); Darrell Kroulik, Cambridge, MN (US); Hideyo Sugimura, North Oaks, MN (US); Xuzhi Qin, Hacienda Heights, CA (US)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 10/630,277

(22) Filed: Jul. 30, 2003

Related U.S. Application Data
(60) Provisional application No. 60/400,345, filed on Jul. 31, 2002.

(51) Int. Cl. B32B 27/36

(52) U.S. Cl. 428/412; 428/422.8; 264/500

(57) ABSTRACT

A photochromic polyurethane laminate that is constructed to solve certain manufacturing difficulties involved in the production of photochromic lenses is disclosed. The photochromic laminate includes at least two layers of a transparent resinous material and a photochromic polyurethane layer that is interspersed between the two resinous layers and which contains photochromic compounds. The photochromic layer has a thickness of from 5 μm to 80 μm. The photochromic host material may be a thermoset or thermoplastic polyurethane. A laminate of this construction can be conveniently incorporated into a plastic lens through an insert injection molding process.

### CROSS REFERENCE TO RELATED APPLICATIONS

This application claims the benefit of priority from U.S. Provisional Application Serial No. 60/400,345 filed Jul. 31, 2002.

### BACKGROUND OF THE INVENTION

1. Field of the Invention

The present invention relates generally to a photochromic laminate that can be applied to polymeric surfaces or can be used by itself as a photochromic element. The invention also relates to a photochromic laminate that is capable of withstanding high temperatures and can be incorporated into plastic lenses by means of injection molding. The invention further relates to a photochromic laminate that exhibits dimensional stability and high-fidelity replication of an internal mold cavity and is suitable for making multi-focal lenses with segment lines.

2. Description of the Related Art

Photochromic articles, particularly photochromic plastic materials for optical applications, have been the subject of considerable attention. In particular, photochromic ophthalmic plastic lenses have been investigated because of the weight advantage and impact resistance they offer over glass lenses. Moreover, photochromic transparencies, e.g. window sheets, for vehicles such as cars, boats and airplanes, have been of interest because of the potential safety features that such transparencies offer.

There are several existing methods to incorporate photochromic properties into plastic lenses. One method involves applying to the surface of a lens a coating containing dissolved photochromic compounds. For example, Japanese Patent Application 3-269507 discloses applying a thermoset polyurethane coating containing photochromic compounds on the surface of a lens. U.S. Pat. No. 6,150,430 also discloses a photochromic polyurethane coating for lenses.

Another method involves coating a lens with a base coating, then imbibing a solution containing photochromic compounds into the base coating material. The most commonly used base material is polyurethane.

However, the two methods described above, which involve coating the lens after it is molded, have significant shortcomings. For example, typically a coating of about 25 μm or more is needed to incorporate a sufficient quantity of photochromic compounds into the base in order to provide the desired light blocking quality when the compounds are activated. This relatively thick coating is not suited for application on the surface of a segmented, multi-focal lens because an unacceptable segment line and coating thickness nonuniformity around the segment line are produced and the desirable smooth surface quality is affected as illustrated at numerals 100 and 200, respectively, in FIG. 1b.

A third conventional method, applicable only to cast resin lenses, is referred to as “in-mass” technology. Photochromic compounds are first dissolved in a liquid lens resin material. The liquid resin is then cast and cured into a photochromic lens blank. The in-mass photochromic technology is primarily used in lenses with a smooth and continuous surface design, i.e., no segments. However, in-mass technology is not suitable for segmented, multi-focal lenses because the different segments have different thicknesses. When the photochromic compounds are activated the different thicknesses, i.e., segments, of the lens result in different visible light transmission.

The use of polycarbonate lenses, particularly in the United States, is widespread. The demand for sunglasses that are impact resistant has increased as a result of extensive outdoor activity. These lenses are produced by an injection molding process and insert injection molding is used to incorporate photochromic properties into the lenses. Insert injection molding is a process whereby a composition is injection molded onto an insert in the mold cavity. For example, as disclosed in commonly assigned U.S. Pat. No. 6,328,446, a photochromic laminate is first placed inside a mold cavity. Polycarbonate lens material is next injected into the cavity and fused to the back of the photochromic laminate, producing a photochromic polycarbonate lens. Because the photochromic function is provided by a thin photochromic layer in the laminate, it is practical to make photochromic polycarbonate lenses with any kind of surface curvature by the insert injection molding method.

Transparent resin laminates with photochromic properties have been disclosed in many patents and publications, for example, Japanese Patent Applications 61-276882, 63-178193, 4-358145, and 9-001716; U.S. Pat. No. 4,889,413; U.S. Patent Publication No. 2002-0197484; and WO 02/093235. The most commonly used structure is a photochromic polyurethane host layer bonded between two transparent sheets. Although the construction of photochromic polyurethane is known, photochromic laminates designed especially for making photochromic polycarbonate lenses through the insert injection molding method are unique.

Problems associated with conventional insert injection molding techniques in the manufacture of photochromic lens are polyurethane bleeding and poor replication of segment lines. “Bleeding” occurs from the deformation of the polyurethane layer during processing. In particular, bleeding occurs when the polyurethane layer melts and escapes from its position between the two transparent sheets of the laminate during the injection molding process. The inventors have discovered that bleeding most frequently results from an excess amount of polyurethane and from using too soft a material. The inventors have also discovered that poor replication of segment lines occurs when the layer of polyurethane is too thick and movement of the laminate occurs as pressure from the mold is applied. These two problems and the resultant multi-focal lens product with unacceptable segment line is illustrated at 300 in FIG. 1a.

Therefore, the need exists to overcome the problems and shortcomings associated with existing polyurethane laminates having photochromic properties and methods of making these laminates. In particular, a need exists to reproducibly manufacturer very sharp, very clear segment lines in photochromic, multi-focal lenses. More particularly, a need exists to reproducibly manufacture photochromic, multi-focal lenses using the insert injection molding process that produces a lens with a sharp segment line and results in little or no bleeding.

### BRIEF SUMMARY OF THE INVENTION

The need and shortcomings of the existing laminates and methods of manufacturing these laminates are met by the polyurethane laminate and method in accordance with the present invention.

It has been discovered that photochromic polycarbonate lenses of high optical quality, with or without segment line(s), can be economically produced from a photochromic laminate comprising a polyurethane layer of from about 5 μm to about 80 μm. The polyurethane may be a thermoplastic polyurethane or a thermoset polyurethane. In a preferred embodiment, the polyurethane is thermoset polyurethane. In addition, it has been discovered that depending on the type of polyurethane used, controlling the thickness of the photochromic layer and certain thermo-mechanical properties play an important role in producing very sharp, very clear segment lines.

It is an object of the present invention to provide an improved transparent resin photochromic laminate that can be used to produce plastic photochromic lenses with or without a segment, multi-focal optical design using insert injection molding.

It is a further object of the present invention to provide a photochromic, polyurethane laminate that exhibits dimensional stability and high-fidelity replication of an internal mold cavity.

It is a further object of the present invention to provide a photochromic, polyurethane laminate that resists the high temperatures and pressures associated with the injection molding process.

It is a further object of the present invention to provide a photochromic, polyurethane laminate that is resistant to bleeding.

It is a further object of the present invention to produce a photochromic, multi-focal lens with sharp segment lines.

These and other objects are achieved by the transparent resin laminate in accordance with the present invention. The present invention comprises a polyurethane layer including photochromic compounds having first and second sides, a front transparent resin sheet bonded to the first side of the polyurethane photochromic layer, and a back transparent resin sheet bonded to the second side of the polyurethane photochromic layer. The front and back transparent resin sheets may be bonded to the polyurethane layer with or without additional adhesive such as epoxies and the acrylate types. The front and back transparent resin sheets are preferably made of the same material as the lens base. That is, if the lens base material is polycarbonate, it is preferred to have polycarbonate resin sheets bonded to the polyurethane photochromic layer. If the lens base material is cellulose acetate butyrate, then it is preferred to have cellulose acetate butyrate resin sheets bonded to the polyurethane photochromic layer. Any clear, transparent plastic resin may be used for the base and resin sheets, for example, polysulfones, polyacrylates and polycycloolefins. The term “front resin sheet” means that the resin sheet is facing the mold cavity to duplicate the front (convex) surface of the whole lens. By the term “back”, we mean that the resin sheet is facing the lens base. The term “lens base” meant the portion of the lens that is molded onto the laminate to form the main portion of the lens.

The objects of the present invention are further achieved by the following technical aspects: (i) a thermoset or thermoplastic polyurethane; (ii) a thickness of the polyurethane photochromic layer of from about 5 μm to about 80 μm; (iii) in thermoplastic polyurethanes, a melting point of from about 150° C. to about 250° C. and an number average molecular weight of from about 150,000 to about 500,000; (iv) a material for the front transparent resin sheet that has a lower glass transition temperature or softening temperature than the back resin sheet.

It has been found that a polyurethane photochromic layer thickness of preferably from about 5 μm to about 80 μm and most preferably from 25 μm to about 50 μm is the best compromise between being thick enough to get enough loading of photochromic compounds in the polyurethane for the desired light blocking at the activated state and being thin enough to eliminate polyurethane bleeding and give the desired sharp replication of the mold cavity.

The photochromic laminate of this invention can be directly used in the insert injection molding process. For lenses having a high diopter front (convex) surface, it is preferred to pre-form the laminate into wafers, or laminates pre-formed into spherically curved shapes, with the given diopter.

Although the photochromic laminate according to this invention is especially suitable for making photochromic polycarbonate lenses through the insert injection molding process, other non-limiting uses include photochromic transparencies such as goggles and face shields.

### BRIEF DESCRIPTION OF THE DRAWINGS

FIG. 1a is a cross sectional view of a multi-focal lens illustrating the problems encountered in the prior art insert injection molding processes when a photochromic laminate is too thick.

FIG. 1b is a cross sectional view of a multi-focal lens illustrating the lack of a sharp segment line and coating thickness nonuniformity when a photochromic material is applied onto multi-focal lenses.

FIG. 2 is a cross sectional view illustrating details of the photochromic polyurethane laminate in accordance with the present invention.

FIG. 3a is a cross sectional view illustrating the insert injection molding process of the utililizing the laminate of the present invention.

FIG. 3b is a cross sectional view of a multi-focal lenses illustrating the sharp segment line produced utilizing the laminate of the present invention.

### DETAILED DESCRIPTION OF THE INVENTION

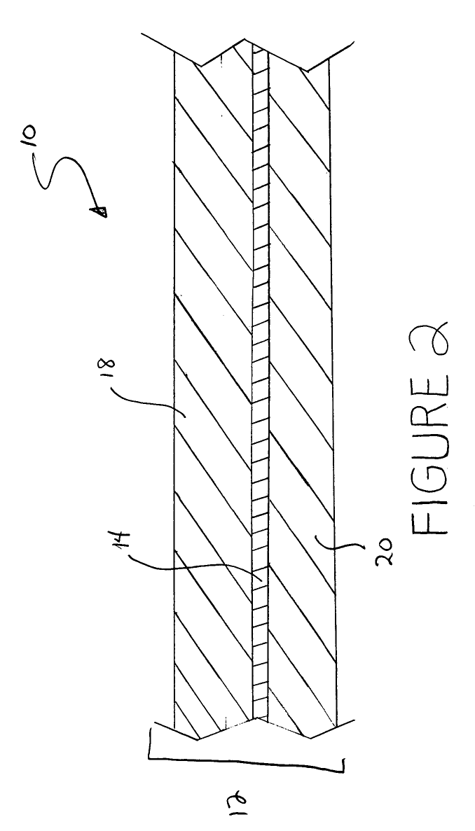

Referring to FIG. 2, there is shown an element 10 in accordance with the present invention. The element 10 comprises a transparent photochromic laminate 12 including a polyurethane layer 14 having dissolved, dispersed or suspended therein a photochromic compound(s, which provides the photochromic functionality, and two transparent resin sheet layers 18, 20 bonded to each side of the polyurethane photochromic layer, with or without additional adhesive. The front and back 18, 20 transparent resin sheets are preferably made of the same material as the lens base. That is, if the lens base material is polycarbonate, it is preferred to have polycarbonate resin sheets bonded to the polyurethane photochromic layer 14. If the lens base material is cellulose acetate butyrate, for example, then it is preferred to have cellulose acetate butyrate resin sheets bonded to the polyurethane photochromic layer 14. Any clear, transparent plastic resin may be used for the lens material and resin sheets, for example, polycarbonates, cellulose esters, polysulfones, polyacrylates, polyamides, polyurethanes, copolymers of acrylates and styrenes and combinations of any of the foregoing. The term “front resin sheet” means that the resin sheet is facing the mold cavity to duplicate the front (convex) surface of the whole lens. By the term “back resin sheet,” we mean that the resin sheet is facing the lens base. The term “lens base” meant the portion of the lens that is molded onto the laminate to form the main portion of the lens.

Suitable photochromic compounds in the context of the invention are organic compounds that, in solution state, are activated (darken) when exposed to a certain light energy (e.g., outdoor sunlight), and bleach to clear when the light energy is removed. They are selected from the group consisting essentially of benzopyrans, naphthopyrans, spirobenzopyrans, spironaphthopyrans, spirobenzoxzines, spironaphthoxazines, fulgides and fulgimides. Such photochromic compounds have been reported which, for example, in U.S. Pat. Nos. 5,658,502, 5,702,645, 5,840,926, 6,096,246, 6,113,812, and 6,296,785; and U.S. patent application Ser. No. 10/038,350, all commonly assigned to the same assignee as the present invention and all incorporated herein by reference.

Among the photochromic compounds identified, naphthopyran derivatives are preferred for optical articles such as eyewear lenses. They exhibit good quantum efficiency for coloring, a good sensitivity and saturated optical density, an acceptable bleach or fade rate, and most importantly good fatigue behavior. These compounds are available to cover the visible light spectrum from 400 nm to 700 nm. Thus, it is possible to obtain a desired blended color, such as neutral gray or brown, by mixing two or more photochromic compounds having complementary colors under an activated state.

More preferred are naphtho[2,1b]pyrans and naphtho[1,2b]pyrans represented by the following generic formula:

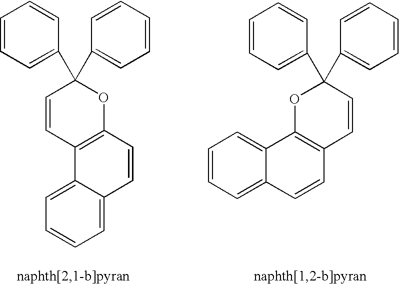

Substituents on various positions of the aromatic structure are used to tune the compounds to have desired color and fading rate, and improved fatigue behavior. For example, a photochromic dye may contain a polymerizable group such as a (meth)acryloyloxy group or a (meth)allyl group, so that it can be chemically bonded to the host material through polymerization.

The quantity of photochromic compound(s) incorporated into the polyurethane layer 14 of the present invention is determined by the desired light blockage in the activated state and the thickness of the polyurethane layer 14 itself. The preferred outdoor visible light transmission of sunglasses is preferably between 10% to 50%, more preferably between 10% to 30%, most preferably between 10% to 20%. Preferably, the amount of total photochromic substance incorporated into or applied on the polyurethane layer may range from about 0.05 wt. % to about 5 wt. % and more preferably from about 0.5 wt. % to about 3.0 wt. %. If the thickness of the polyurethane layer is 80 μm, between about 0.5 wt. % to about 1 wt. % of photochromic compound(s) is needed to achieve a outdoor light transmission of between 10% to 20%. The amount of photochromic compound(s) needed is inversely proportional to the thickness of the polyurethane layer. In other words, to achieve the same outdoor light transmission the thicker the polyurethane layer, the lower the concentration of photochromic compound(s) needed. The concentration of the photochromic compound(s) also depends on the color intensity of the photochromic compound(s) at the activated state.

According to the first technical aspect of the present invention, a desired thickness of from about 5 μm to about 80 μm is required for the photochromic polyurethane layer in order to eliminate or reduce bleeding to an acceptable level in production, and to produce an acceptable segment line replication for segmented multi-focal lenses. As discussed previously, both poor segment line replication and polyurethane bleeding relate to the deformation of the polyurethane layer. During the injection molding cycle, temperatures of from about 250° F. to about 400° F., or from about 121° C. to about 204° C., may be reached. Assuming that the polyurethane material does not melt during the molding cycle, it is still significantly softer than the polycarbonate or other transparent resin sheet materials. According to Lindley (Lindley, P. B., 1978, “Engineering Design With Natural Rubber,” Malaysian Rubber Producer's Research Association, Hertford, GB), the apparent compression modulus, E_{c}, of a thin rubbery disc can be estimated by the following semi-empirical equation:

E_{c}=3G(1+2S²)

where G is the shear modulus, and S is the shape factor of the disc:

S=D/(4hₒ)

where D is the diameter of the disc, and h₀ is the thickness of the disc. When the normal compression deformation of the polyurethane layer is small, the simple Hookean formula can be used to estimate its normal strain, ε′.

ε=σ/E_{c}

where σ is the compression pressure. Thus, reducing the thickness of the polyurethane layer will significantly increase its stiffness, and decrease its compression deformation. Consequently, for a given mold clamping, the front transparent resin sheet will be pushed harder against the mold cavity to give better replication of the surface and segment line. Similarly, because polyurethane is nearly incompressible, decreasing the compression deformation of the polyurethane layer means less material bulging laterally, that is, less bleeding.

A photochromic laminate having a polyurethane layer of from about 5 μm to about 80 μm in accordance with the present invention may be produced through processes known to those skilled in the art. Depending on the nature of the starting material to the polyurethane, processes such as casting—lamination (also referred to in the art as coating—lamination), and extrusion—lamination may be used. The polyurethane layer utilizing a thermoplastic polyurethane (TPU) can be obtained by either casting or extrusion. To cast the TPU, selected photochromic compounds and other necessary additives are first dissolved in a suitable solvent or in a mix of solvents to produce a solution. The solution is then cast on a release liner, dried, and transferred to a first transparent resin sheet through hot-lamination. The second resin sheet is laminated next. For most TPUs, hot-lamination at a temperature close to the softening point should provide sufficient adhesion so that no additional adhesive is needed.

The polyurethane solution may be cast with methods known to those skilled in the art, including knife-over-roll, reverse-roll, gravure, etc. If the solvent selected to dissolve the polyurethane does not whiten the resin sheet, a direct cast on the resin sheet may be employed.

Examples of suitable solvents that may be used to dissolve polyurethanes include cyclohexane, toluene, xylene and ethyl benzene, esters such as ethyl acetate, methyl acetate, isopropyl acetate, n-propyl acetate, isobutyl acetate, n-butyl acetate, isoamyl acetate, methyl propionate and isobutyl propionate, ketones such as acetone, methylethyl ketone, diethyl ketone, methylisobutyl ketone, acetyl acetone and cyclohexyl ketone, ether esters such as cellosolve aetate, diethylglycol diaetate, ethyleneglycol mono n-butylether acetate, propylene glycol and monomethylether acetate, tertiary alcohols such as diacetone alcohol and t-amyl alcohol and tetrahydrofuran. Ethyl acetate, methyl ethyl ketone, tetrahydrofuran, toluene and combinations thereof are preferable.

When utilizing the solution casting—lamination process, it is desirable to keep solvent retention in the polyurethane layer and the resin sheet layers at a minimum level. The solvent retention should preferably be less than 3 wt. %, more preferably less than 2 wt. %, and most preferably less than 1 wt. %. Conventional methods such as hot air dryers may be used to evaporate the solvent before lamination.

In an alternative process, the photochromic layer from a TPU may be extruded and laminated between the two transparent resin sheets. The photochromic compounds and other additives may be incorporated into the polyurethane during the resin synthesis stage or melt-mixed prior to extrusion.

As will be described in detail, a thermoset polyurethane is preferably used to make the photochromic polyurethane layer in the laminate of the present invention.

Japanese Patent Application 2002-196103 discloses a process that may be used to produce the transparent resin laminate with photochromic property in accordance with the present invention. A photochromic organic compound and other additives are mixed, with given weight percentage loading, with a polyurethane prepolymer while stirring. The prepolymer may be diluted with an organic solvent selected from the aforementioned solvent group to aid in the solubility of the photochromic compound and additives. A curing agent is added in an I/H ratio of isocyanate group (I) to hydroxyl group (H) of from about 0.9 to 20 and preferably from about 1 to 10. The mixture is stirred to form a solution. It is suitable that the polymer concentration in the solution thus obtained is from about 40 wt. % to about 95 wt. %. The solution is coated on one side of a transparent resin sheet with a coating thickness of from about 5 μm to 500 μm. The coating is then substantially heat-dried at from about 40° C. to about 100° C. for 5 to 60 minutes in order to evaporate any solvent remaining on the coated surface. The second transparent resin sheet is laminated to the coated surface of the first resin sheet in a sandwich form. The laminate sheet thus obtained is heated at a temperature of from about 60° C. to about 140° C. for 2 hours to 1 week to cure the polyurethane prepolymer containing the curing agent, whereby a transparent synthetic resin laminate is obtained.

The thickness variation of the photochromic polyurethane layer should be controlled in order to produce a uniform light blockage at the activated state. A thickness variation of less than 20% over the width of the laminate is required and preferably less than 15% and more preferably less than 10%.

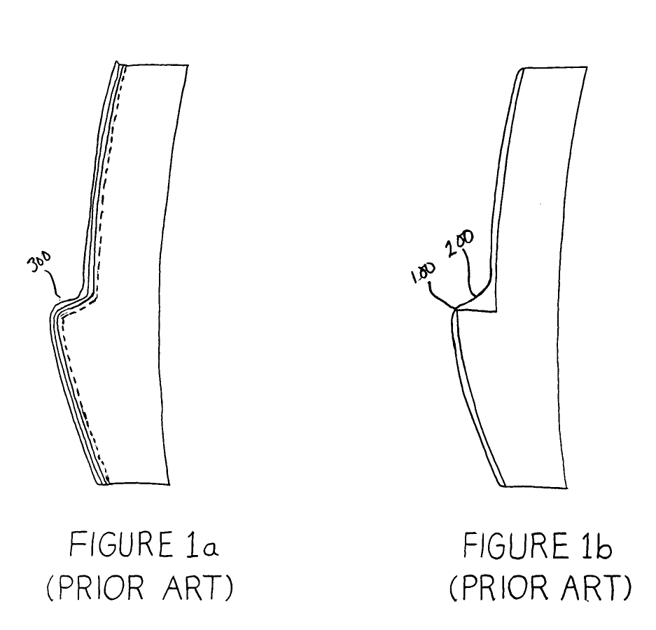

According to the second technical aspect of the laminate in accordance with the present invention, if a thermoplastic polyurethane material is used for the photochromic layer, a melting point of from about 150° C. to about 250° C. and a number average molecular weight of from bout 150,000 to about 500,000 is preferred. More preferably the number average molecular weight of the thermoplastic polyurethane will be from about 150,000 to about 350,000. During the mold cavity filling period, melted polycarbonate is injected into the mold, and the polyurethane layer is subjected to temperatures from 120° C. to 2000° C. It is necessary for the particular polyurethane selected to withstand these high temperatures and to maintain the mold cavity filled shape. If the polyurethane melts during the filling period, substantial bleeding will occur. A laminate in accordance with the melting point and molecular weight characteristics of present invention will produce a bleed-free and thin segment line photochromic lens. It is desirable that the thermoplastic polyurethane selected has a higher melting point than the mold temperature. Because a thermoset polyurethane will not melt before decomposition, a thermoset polyurethane photochromic layer in the laminate of this invention is most preferred. As mentioned previously, if a thermoplastic polyurethane is used that does not have the desired melting point and molecular weight characteristics the normal compression deformation of the polyurethane layer will prevent the exact replication of the mold cavity surface; and if a segmented multi-focal lens is being produced, a thick segment line will develop as depicted in FIG. 1a.

Thermoplastic polyurethanes may be made from a diisocyanate, a polyol, and a chain extender. The polymerization can be carried out in one-pot fashion, that is, all starting materials are initially added into the reaction vessel. However, a prepolymer approach is more preferred in order to yield a high molecular weight polyurethane. In this preferred approach, a polyurethane prepolymer is first obtained by reacting a stoichiometrically in excess diisocyanate with a polyol. A chain extender of diol or diamine is then mixed with the prepolymer. The ratio of hydroxyl or amine groups to isocyanate groups in the mixture is close to unity, but may vary from 1.0 to 1.2.

A thermoset polyurethane may also be obtained with a prepolymer approach as in making thermoplastic polyurethanes. Thermoset (i.e., cross-linking) may be achieved by using a curing agent that has a functionality higher than 2, e.g., a triol or mix of a diol and a triol, or by having an significant excess of diisocyanate. The excess isocyanate will form cross-linking points with urethane and urea groups to prevent the melting of the polyurethane.

The polyol is selected from a group consisting of polyester polyol, polyether polyol, and polycarbonate polyol. It is preferable to use polycaprolactone polyol having an average molecular weight from 300 to 3,000, and preferably from 1,000 to 2,000. The resulting polyurethane prepolymer will have an average molecular weight from 1,500 to 6,000.

The diisocyanate component is preferably an aliphatic diisocyanate. The aliphatic diisocyanate is selected from the group consisting of 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl)-methane, 2,4′-dicyclohexylmethane diisocyanate, 1,3- and 1,4-bis-(isocyanatomethyl)-cyclohexane, bis-(4-isocyanato-3-methylcyclohexyl)-methane, .alpha.,.alpha.,.alpha.′,.alpha.′-tetramethyl-1,3- and/or -1,4-xylylene diisocyanate, 1-isocyanato-1-methyl-4(3)-isocyanatomethyl cyclohexane, 2,4- and/or 2,6-hexahydrotoluylene diisocyanate, and mixtures thereof. Bis-(4-isocyanatocyclohexl)-methane is the preferred diisocyanate in occurrence with the method of the present invention.

The curing agent may be a polyol selected from the group consisting of polyurethane polyol, polyether polyol, polyester polyol, acryl polyol, polybutadiene polyol and polycarbonate polyol. Polyurethane polyol with an end-group hydroxyl obtained from specific isocyanate and specific polyol is preferable. The number average molecular weight of the curing agent is preferably from about 500 to about 5,000, more preferably from about 1,500 to about 4,000, and most preferably from about 2,000 to about 3,000.

The curing agent may also be a low molecular weight diol or triol. Suitable diols and triols with number average molecular weights from about 60 to about 500 that may be used in accordance with the present invention include the polyhydric alcohols listed above to form polyester polyols. Triols such as trimethylolpropane (TMP), glycerine or low molecular weight polypropylene oxide polyols prepared from these or similar trifunctional starters are preferred.

The curing agent may also be a non-yellowing aliphatic or aromatic diamine or triamine.

Photochromic compounds, additives such as a light stabilizer and an antioxidant, and a curing catalyst are added into the polyurethane prepolymer before curing.

Additives such as antioxidants and light stabilizers are incorporated into the polyurethane layer in order to improve the fatigue resistance of the photochromic compounds. Hindered amines are usually used as light stabilizers, and hindered phenols are usually used as antioxidants. Preferred hindered amine light stabilizers include, bis(1,2,2,6,6-pentamethyl-4-piperidinyl)-sebacate, or a condensation product of 1,2,2,6,6-pentamethyl-4-piperidinol, tridodecyl alcohol and 1,2,3,4-butanetetra caboxylic acid as tertiary hindered amine compounds. Preferred phenol antioxidants include, 1,1,3-tris(2-methyl-4-hydorxy—5-t-butylphenyl)butane, tetrakis-[methylene-3-(3′,5′-di-t-butyl-4′-hydroxy-phenyl)propionate]methane, and 1,3,5-tris(3,5-di-t-butyl-4-hyroxybenzyl)-1,3,5-triazine-2,4,6-(1H,3H,5H)-trione. Phenol antioxidants that contain 3 or more hindered phenols are preferable.

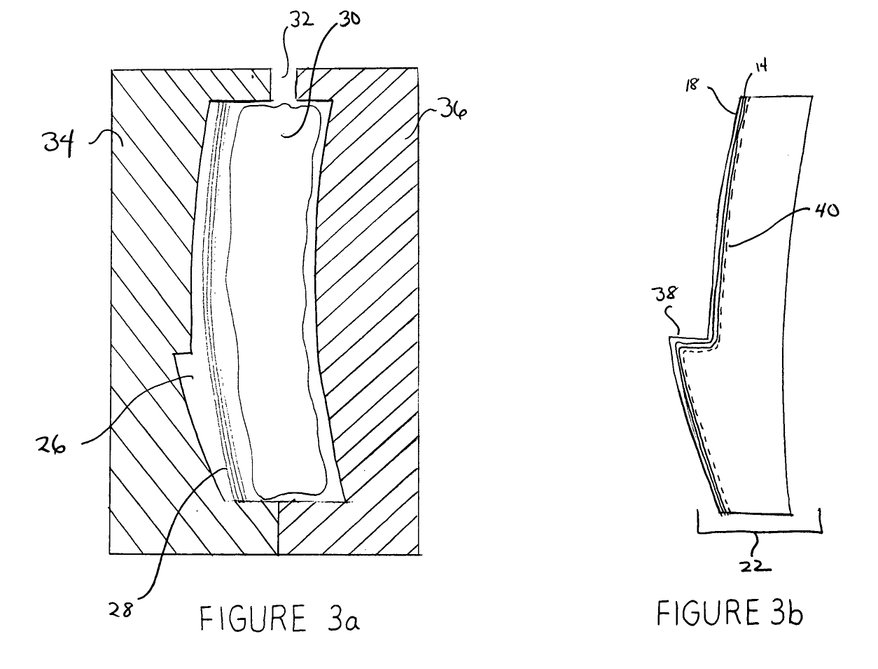

According to a third technical aspect of the present invention, the transparent resin sheets of a photochromic laminate may be made from the same resin material as the base lens or may be different. Preferably, the resin material is thermally fusible to the lens base material so that a photochromic lens will have its photochromic laminate tightly integrated with the lens base when produced with the insert injection molding process as can best be seen in FIG. 3b at 40. Thus, it is preferred to have the same or substantially similar materials for both the lens base and the transparent resin sheets. It also is desirable to have the front resin sheet softer than the back resin sheet under the mold temperature to provide better replication of the mold cavity surface. By the term “softer,” we mean that the front sheet resin has a lower glass transition temperature or softening temperature or melt viscosity or molecular weight than the back sheet resin, and/or that the front sheet resin is thinner than the back resin sheet. It is also preferred to have the lens base resin softer than the back sheet resin so that the rigidity of the laminate can be maintained during the molding process. When polycarbonate comprises the sheet resin, for example, the molecular weight of the back sheet resin should be 25,000 or greater and the molecular weight of the front sheet resin and the injected resin should be from 15,000 to 25,000.

Suitable sheet resin materials include polycarbonate, polysulfone, cellulose acetate butyrate (CAB), polyacrylates, polyesters, polystyrene, copolymer of an acrylate and styrene, blends of compatible transparent polymers. Preferred resins are polycarbonate, CAB, polyacrylates, and copolymers of acrylate and styrene. A polycarbonate-based resin is particularly preferred because of high transparency, high tenacity, high thermal resistance, high refractive index, and most importantly, compatibility with the polycarbonate lens base material. A typical polycarbonate based resin is polybisphenol-A carbonate. In addition, examples of the polycarbonate based resin include homopolycarbonate such as 1,1′-dihydroxydiphenyl-phenylmethylmethane, 1,1′-dihydroxydiphenyl-diphenylmethane, 1,1′-dihydroxy-3,3′-dimethyldiphe-nyl-2,2-propane, their mutual copolymer polycarbonate and copolymer polycarbonate with bisphenol-A.

While the thickness of a transparent resin sheet is not particularly restricted, it is typically 2 mm or less, and preferably 1 mm or less but not less than 0.025 mm.

Although the photochromic laminate according to the present invention is especially suitable for making photochromic polycarbonate lenses through the insert injection molding process described in commonly assigned U.S. Pat. No. 6,328,446, it can also be used as-is for other photochromic transparencies such as goggles and face shields. The photochromic laminate may also be incorporated into other types of eyewear lenses such as cast resin lenses. In the case of cast resin lenses, the laminate is usually formed as a curved wafer having a spherical surface. The wafer can then be integrated with the lens base material by insert casting as described in U.S. Pat. No. 5,286,419.

Referring to FIGS. 3a and 3b, to produce a photochromic polycarbonate lens 22 with the photochromic layer 14 of the present invention utilizing an insert injection molding process, photochromic discs are cut out of the photochromic laminate. The size of the discs is defined by the injection molding lens cavity 26. The cut can be made in a number of ways, including by rolling knife cutter, reciprocal stamping cutter, straight-edge cutting knife moved translationally along a cut-line, a rotary or swing die traversed along a line or by laser cutter.

The discs are then formed into wafers of a given diopter. The base curve diopter of the wafers is determined by the convex side curvature of the finished photochromic lenses. The forming process may be performed thermally with or without pressure or vacuum. It is convenient to utilize a platen having a forming surface that corresponds at least substantially or precisely to, the predetermined curvature of the convex side of the lens to be formed. This permits the convex side of the thermoformed lens blank to have substantially or precisely the refractive power desired in the finished lens and avoids the need to surface or grind the convex side of the lens blank. The temperature for forming will vary with the material of the transparent resin sheets. In general, the thermoforming temperature is close to but lower than the glass transition temperature of the resin material. For example, a suitable forming temperature for the photochromic laminate with polycarbonate resin sheets will be from about 125° C. to 150° C. Often it will be beneficial to preheat the blank, for example, in the case of polycarbonate sheets, to a temperature from about 80° C. to 120° C. for 5 to 20 minutes.

The formed wafer 28 is then placed in the mold cavity 26 and lens base resin material 30 is injection molded on the back of the wafer 28 as follows.

Once the formed wafer has been placed into the mold cavity 26, the two mold halves 34, 36 close and molten base lens resin material 30 is injected into the mold through gate 32. The combined action of high temperature from the molten resin and high pressure from the injection screw confirm the wafer 28 to the surface of the mold cavity 26, which results in the finished product, a photochromic lens 22 having sharp segment lines 32.

After a photochromic lens is made, the front layer may be coated with functional coatings such as with an abrasion resistant coating, antireflective coating, and/or an anti-fog hard coating.

The photochromic polyurethane laminate in accordance with the present invention will now be illustrated with reference to the following examples, which are not to be construed as a limitation upon the scope of the invention in any way. In the examples, all values are expressions of weight %. CR49 and CR59 are tradenames of photochromic dyes available from Corning Incorporated (Corning, N.Y.), Uvinul® 3040 available from BASF (Mount Olive, N.J.) and Tinuvins® available from CIBA (Tarrytown, N.Y.) are UV absorbers and stabilizers.

### EXAMPLE 1

A photochromic polyurethane laminate having two 300 μm thick polycarbonate sheets bonded to a 38 μm cross-linked polyurethane layer was made Mitsubishi Gas Chemicals (Tokyo, Japan). The laminate was cut into a 76 mm disc and used to make a segmented multi-focal lens. After the insert injection molding process with common molding parameters, the finished lens has an acceptable thin, crisp segment line. No polyurethane bleeding from the laminate is observed.

### Example 1A

A photochromic polyurethane laminate as in Example 1, having two 300 μm thick polycarbonate sheets bonded to a 51 μm cross-linked polyurethane layer, was cut in a 76 mm disc and used to make a segmented multi-focal lens. After the insert injection molding process with common molding parameters, the finished lens had an acceptable thin, crisp segment line. No polyurethane bleeding from the laminate was observed.

### Example 1B

A photochromic polyurethane laminate as in Example 1, having two 300 μm thick polycarbonate sheets bonded to a 76 μm cross-linked polyurethane layer, was cut into a 76 mm disc and used to make a segmented multi-focal lens. After the insert injection molding process with common molding parameters, the finished lens had an acceptable thin segment line. Slight, but still acceptable, polyurethane bleeding from the laminate is observed.

### COMPARISON EXAMPLE 1

A photochromic polyurethane laminate as in Example 1, having two 300 μm thick polycarbonate sheets bonded to a 102 μm cross-linked polyurethane layer was cut into a 76 mm disc and used to make a segmented multi-focal lens. After the insert injection molding process with common molding parameters, the finished lens had an unacceptable thick segment line. Polyurethane bleeding from the laminate was observed.

### EXAMPLE 2

A 5% polyurethane solution in tetrahydrofuran is obtained from a thermoplastic polyurethane having a number average molecular weight of 260,000. To the solution are also dissolved 3.0% of a gray photochromic dye, 2.0% of Tinuvin® 144, and 2.0% of Tinuvin® 765. The solution is cast with a doctor blade on a silicone release liner. The cast film is dried at 60° C. for 10 minutes on a hot plate and then 100° C. for another 30 minutes in a hot air dryer. The dried film is transfer-laminated to two 380 μm thick sheets of polycarbonate (GE, New York, N.Y.) on a hot-roll laminator at 130° C.

The laminate had a polyurethane layer of 25 μm thick. It was cut into a 76 mm disc and used to make a segmented multi-focal lens. After the insert injection molding process with common molding parameters, the finished lens had an acceptable thin, sharp, crisp segment line. No polyurethane bleeding from the laminate was observed.

### EXAMPLE 3

The procedure of Example 2 was followed, except the polyurethane had a number average molecular weight of 70,000 and a 20% solution was obtained. The photochromic polyurethane layer was 25 μm thick. The finished lens had a thick segment line that was not acceptable. Polyurethane bleeding from the laminate was observed.

### COMPARISON EXAMPLE 3

The same polyurethane material as Example 2 was extruded into a 178 μm thick film. The polyurethane also contained the following additives: CR49 0.66%, CR59 0.10%, Uvinul® 3040 0.30%, Tinuvin® 144 2.00%, Tinuvin® 765 2.00%.

Two sheets of 380 μm thick polycarbonate (GE) were bonded to the two sides of the polyurethane film through a vacuum lamination process. The laminate so obtained was formed into a wafer of 5.7 diopter. The wafer was used to make a segmented multi-focal lens. After the insert injection molding process with common molding parameters, the finished lens had a thick segment line that was not acceptable. Sever polyurethane bleeding was also observed.

### EXAMPLE 4

To 10 g of Hysole (Loctite) U-10FL urethane adhesive resin are dissolved 1.5% of a gray photochromic dye, 2.0% of Tinuvin® 144, and 2.0% of Tinuvin® 765. 9.1 g of Hysol® (Loctite) U-10FL urethane adhesive hardener is mixed in to form a uniform liquid adhesive. The solution is used to laminate a 380 μm thick polycarbonate sheet to a 300 μm thick poly(methyl methacrylate) (PMMA) sheet on a roll laminator. The adhesive is allowed to cure at room temperature overnight, then is post cured at 65° C. for 10 hours. The glass transition temperatures are 150° C. and 100° C. for the polycarbonate and PMMA, respectively.

The photochromic polyurethane laminate obtained is subjected to insert injection molding to make a segmented multi-focal lens. The PMMA sheet faces the front mold cavity surface. An optical quality polycarbonate resin available from GE (New York, N.Y.) is used as the injection lens material. With molding conditions know to those skilled in the art, the PMMA sheet replicates the cavity well, and the finished photochromic lens has a thin and acceptable segment line.

The foregoing detailed description of the preferred embodiments of the invention has been provided for the purposes of illustration and description. They are not intended to be exhaustive or to limit the invention to the precise embodiments disclosed. Many modifications and variations will be apparent to practitioners skilled in the art to which this invention pertains. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

What is claimed is:

1. A method of creating a sharp segment line on an insert injection molded multi-focal, photochromic lens comprising:
providing an photochromic insert having a polyurethane layer including photochromic compounds, the photochromic polyurethane layer having a thickness of from about 5 μm to about 80 μm;
placing said photochromic insert in an injection mold cavity;
injecting lens material into the cavity;
producing a multi-focal, photochromic lens having a sharp segment line.

2. The method of claim 1 wherein said photochromic polyurethane layer has a thickness of from about 25 μm to about 50 μm.

3. The method of claim 1 wherein said lens material is selected from the group consisting of polycarbonates, cellulose esters, polysulfones, polyacrylates, polyamides, polyurethanes, copolymers of acrylates and styrenes and combinations of the foregoing.

4. The method of claim 1 wherein said photochromic polyurethane layer includes a top side and a bottom side, said top side being bonded to a front transparent resin sheet and said bottom side being bonded to a back transparent resin sheet.

5. The method of claim 4 wherein said photochromic polyurethane layer comprises a thermoset polyurethane.

6. The method of claim 4 wherein said photochromic polyurethane layer comprises a thermoplastic polyurethane.

7. The method of claim 6 wherein said thermoplastic polyurethane has a melting point of from about 150° C. to about 250° C.

8. The method of claim 6 wherein said thermoplastic polyurethane has a number average molecular weight of from about 150,000 to about 350,000.

9. The method of claim 7 wherein said thermoplastic polyurethane has a number average molecular weight of from about 150,000 to about 350,000.

10. The method of claim 4 wherein said polyurethane layer is bonded to said front resin sheet and said back resin sheet with an adhesive.

11. The method of claim 10 wherein said adhesive is an epoxy type.

12. The method of claim 10 wherein said adhesive is an acrylate type.

13. The method of claim 10 wherein said adhesive is a polyurethane.

14. The method of claim 4 wherein said bond forms from hot lamination at a temperature near the softening point of the polyurethane layer to the material of the front and back resin sheet layers.

15. The method of claim 4 wherein at least one of said front and said back resin sheet layers is thermally fusible with the injected lens material.

16. The method of claim 15 wherein said front and back resin sheet layers comprise polycarbonate.

17. The method of claim 4 wherein said photochromic compound is selected from the group consisting essentially of benzopyrans, naphthopyrans, spirobenzopyrans, spironaphthopyrans, spirobenzoxzines, spironaphthoxazines, fulgides and fulgimides.

18. The method of claim 6 wherein said photochromic compound is selected from the group consisting essentially of benzopyrans, naphthopyrans, spirobenzopyrans, spironaphthopyrans, spirobenzoxzines, spironaphthoxazines, fulgides and fulgimides.

19. The method of claim 17 wherein said photochromic compound is selected from the group consisting essentially of naphtho[2,1b]pyrans and naphtho[1,2b]pyrans.

20. The method of claim 18 wherein said photochromic compound is selected from the group consisting essentially of naphtho[2,1b]pyrans and naphtho[1,2b]pyrans.

21. A method of creating a sharp segment line on an insert injection molded multi-focal lens comprising:
providing an photochromic insert comprising a polyurethane laminate including a front resin sheet, a back resin sheet, and a polyurethane layer including a photochromic compound, said photochromic polyurethane layer disposed between and bonded to said front and back resin sheet, said photochromic laminate having a thickness of from about 5 μm to about 80 μm;
placing said photochromic insert in an injection mold cavity;
injecting polycarbonate lens material into the cavity;
producing a multi-focal lens having a sharp segment line.

22. The method of claim 21 wherein said photochromic insert has a thickness of from about 25 μm to about 50 μm.

23. The method of claim 21 wherein said polyurethane layer comprises a thermoset polyurethane.

24. The method of claim 21 wherein said polyurethane layer comprises a thermoplastic polyurethane.

25. The method of claim 24 wherein said thermoplastic polyurethane has a melting point of from about 150 to about 250.

26. The method of claim 24 wherein said thermoplastic polyurethane has a number average molecular weight of from about 150,000 to about 500,000.

27. The method of claim 25 wherein said thermoplastic polyurethane has a number molecular weight of from about 150,000 to about 500,000.

28. The method of claim 21 wherein said photochromic compound is selected from the group consisting essentially of benzopyrans, naphthopyrans, spirobenzopyrans, spironaphthopyrans, spirobenzoxzines, spironaphthoxazines, fulgides and fulgimides.

29. The method of claim 28 wherein said photochromic compound is selected from the group consisting essentially of naphtho[2,1b]pyrans and naphtho[1,2b]pyrans.

30. A transparent polychromic polyurethane laminate comprising:
a front transparent resin sheet;
a back transparent resin sheet;
a photochromic polyurethane layer, said photochromic polyurethane layer including a photochromic compound dissolved therewithin, said photochromic polyurethane layer having a top side and a bottom side, said top side bonded to said front transparent resin sheet and said bottom side bonded to said back transparent resin sheet,
wherein said photochromic polyurethane layer has a thickness of from about 5 μm to about 80 μm.

31. The laminate of claim 30 wherein said photochromic polyurethane layer has a thickness of from about 25 μm to about 50 μm.

32. The laminate of claim 30 wherein said polyurethane is a thermoset polyurethane.

33. The laminate of claim 30 wherein said polyurethane is a thermoplastic polyurethane.

34. The laminate of claim 30 wherein said polyurethane has a number average molecular weight of from 150,000 to 500,000.

35. The laminate of claim 33 wherein said polyurethane has a melting point of from about 150° C. to about 250° C.

36. The laminate of claim 30 wherein said photochromic compound is selected from the group consisting essentially of benzopyrans, naphthopyrans, spirobenzopyrans, spironaphthopyrans, spirobenzoxzines, spironaphthoxazines, fulgides and fulgimides.

37. The laminate of claim 30 wherein said photochromic compound is selected from the group consisting essentially of naphtho[2,1b]pyrans and naphtho[1,2b]pyrans.

38. A method of reducing bleeding on an insert injection molded photochromic lens comprising:
providing an photochromic insert having a polyurethane layer including photochromic compounds, the photochromic polyurethane layer having a thickness of from about 5 μm to about 80 μm;
placing said photochromic insert in an injection mold cavity;
injecting lens material into the cavity;
producing a photochromic lens.

39. The photochromic lens of claim 38 wherein said photochromic lens is a multi-focal lens.
